(19) United States
(12) Patent Application Publication
(10) Pub. No.: US 2026/0092688 A1
(43) Pub. Date: Apr. 2, 2026

(54) LAMP MODULE AND VEHICLE LAMP INCLUDING THE SAME

(71) Applicant: SL Corporation, Daegu (KR)

(72) Inventor: Hyojin HAN, Gyeongsan-si (KR)

(21) Appl. No.: 19/317,015

(22) Filed: Sep. 2, 2025

Related U.S. Application Data
(63) Continuation of application No. PCT/KR2024/095184, filed on Feb. 15, 2024.

(30) Foreign Application Priority Data
Mar. 2, 2023 (KR) 10-2023-0027640

(51) Int. Cl. F21S 41/62; F21S 41/255; F21S 41/26; F21S 41/265; F21V 5/00; F21V 5/04; F21W 102/13; F21Y 101/00

(52) U.S. Cl. CPC F21S 41/62; F21S 41/255; F21S 41/26; F21S 41/265; F21V 5/008; F21V 5/043; F21W 2102/13; F21Y 2101/00

(57) ABSTRACT

A lamp module capable of forming an optimal beam pattern that satisfies light distribution characteristics includes a light source unit that generates light; and an optical unit that transmits at least a portion of the light incident from the light source unit so as to form a predetermined beam pattern. The optical unit is inclined in the left and right directions such that a first lateral side thereof is disposed in front of a second lateral side thereof, and the optical unit includes an incident lens unit including a plurality of incident lenses; and an exit lens unit including a plurality of exit lenses corresponding to the plurality of incident lenses.

### CROSS-REFERENCE TO REPLATED APPLICATIONS

This application is a Continuation of International Application No. PCT/KR2024/095184 filed Feb. 15, 2024, which claims priory from Korean Application No. 10-2023-0027640 filed Mar. 2, 2023. The aforementioned applications are incorporated herein by reference in their entireties.

### TECHNICAL FIELD

The present disclosure relates to a lamp module and a vehicle lamp including the same, and more particularly, to a lamp module capable of forming an optimal beam pattern that satisfies light distribution characteristics, and a vehicle lamp including the same.

### RELATED ART

In general, vehicles are equipped with various types of vehicle lamps that serve an illumination function to allow easier identification of objects located around the vehicles during low-light conditions (e.g., nighttime driving) and a signaling function to inform other vehicles or road users of the driving status of the vehicles.

For example, headlamps and fog lamps are primarily intended for the illumination function, while turn signal lamps, tail lamps, and brake lamps are primarily intended for the signaling function. Such vehicle lamps are regulated by law with respect to installation standards and specifications so that each function can be fully achieved.

Among such vehicle lamps, headlamps need to secure a sufficient viewing distance and viewing range so that the driver's forward visibility can be ensured, and for this purpose, an optical system is separately used to satisfy the light distribution characteristics corresponding to both the viewing distance and viewing range.

However, when separate optical systems are used to secure a sufficient viewing distance and viewing range, the configuration becomes more complex, and costs increase. Therefore, a solution is required that allows the configuration to be simplified while still satisfying the required light distribution characteristics.

In addition, a vehicle lamp may need to have its optical system installed in a tilted manner depending on the body line of the vehicle. In such cases, the direction in which light is irradiated changes, making it more difficult to form a beam pattern that satisfies the desired light distribution characteristics. Therefore, a solution is required that enables an optimal beam pattern to be formed even when the optical system is installed in a tilted manner according to the vehicle's body line.

### SUMMARY

One objective of the present disclosure is to provide a lamp module and a vehicle lamp including the same, which allow different light distribution characteristics to be simultaneously implemented so that an optimal beam pattern can be formed.

Another objective of the present disclosure is to provide a lamp module and a vehicle lamp including the same, which can form a beam pattern satisfying the light distribution characteristics even when the optical system is installed in a tilted manner according to the body line of the vehicle.

The objectives of the present disclosure are not limited to those mentioned above, and other objectives not explicitly stated will be clearly understood by those skilled in the art based on the following description.

According to an aspect of the present disclosure, a lamp module may include a light source unit that generates light; and an optical unit that transmits at least a portion of the light incident from the light source unit to form a predetermined beam pattern. The optical unit may be inclined such that a first lateral side thereof is disposed more forward than a second lateral side thereof in a left-right direction, and includes: an incident lens unit including a plurality of incident lenses; and an exit lens unit including a plurality of exit lenses corresponding to the plurality of incident lenses.

The plurality of incident lenses may be divided into a plurality of sections arranged in a vertical direction, and the plurality of sections may include: a first section having a first light distribution characteristic; and a second section having a second light distribution characteristic. The optical unit may be configured such that the first section and the second section are alternately arranged in at least some regions.

The first section and the second section may be alternately arranged in at least one of an upper region or a lower region of the optical unit.

The first section may include at least one first lens row formed to extend in the left-right direction, and the second section may include at least one second lens row formed to extend in the left-right direction. The plurality of incident lenses may include a first incident lens that forms the at least one first lens row and including a plurality of incident regions having different light-condensing performances; and a second incident lens that forms the at least one second lens row.

The second incident lenses may be implemented as cylindrical lenses.

The at least one first lens row may include a plurality of first lens rows arranged in a vertical direction, and the at least one second lens row may include a single second lens row.

A number of first lens rows may be greater than a number of second lens rows.

Light incident on the first incident lens may be emitted through at least one of adjacent first or second exit lenses among the plurality of exit lenses, and the plurality of incident regions may include a first incident region and a second incident region having different widths in the left-right direction.

The first incident region may condense light incident on the first incident lens at or near a rear focal point of a corresponding exit lens among the first and second exit lenses, thereby allowing a high-luminance region of the beam pattern to be enhanced.

The second incident region may be configured such that light incident on the second incident lens is emitted through at least one of the first exit lens or the second exit lens, and may be condensed at a position more rearward compared to the first incident region.

The plurality of incident regions may further include a third incident region formed between the first incident region and the second incident region and configured to allow light incident on the first incident lens to proceed as substantially collimated light.

A central axis of each of the plurality of exit lenses may be tilted in a direction toward the first lateral side of the optical unit with respect to a reference axis parallel to an optical axis of the light source unit, and each of the plurality of exit lenses may be formed in a configuration in which a region disposed in the second lateral side of the optical unit with respect to the central axis is larger than a region disposed in the first lateral side of the optical unit.

The light source unit may include: a light source that generates the light; and a light path adjuster that adjusts a path of the light emitted from the light source. The light source may be disposed below a center of the light path adjuster.

According to another aspect of the present disclosure, a vehicle lamp may be configured to provide a beam pattern that is formed by a plurality of lamp modules arranged in one direction. Each of the plurality of lamp modules may include a light source unit that generates light; and an optical unit that transmits at least a portion of the light incident from the light source unit to form a predetermined beam pattern. The optical unit may be inclined to allow a first lateral side thereof to be disposed more forward than a second lateral side thereof in a left-right direction, and may include an incident lens unit including a plurality of incident lenses; and an exit lens unit including a plurality of exit lenses corresponding to the plurality of incident lenses.

The light source unit may include: a light source that generates the light; and a light path adjuster that adjusts a path of the light emitted from the light source. The light source may be disposed below a center of the light path adjuster.

In at least one of the plurality of lamp modules, the light source may be disposed closer than at least another of the plurality of lamp modules to a center of the light path adjuster in the left-right direction.

Other specific details of the present disclosure are included in the detailed description and the drawings.

The vehicle lamp according to the present disclosure may provide one or more of the following effects.

Since different incident lenses, among a plurality of incident lenses, are formed to have different light distribution characteristics, the light distribution characteristics of a required beam pattern can be satisfied.

In addition, since at least some of the plurality of incident lenses include multiple incident regions having different light-condensing performances, and a predetermined region of a beam pattern can be enhanced by the multiple incident regions, an optimal beam pattern can be more readily facilitated.

Furthermore, since the central axes of a plurality of exit lenses are formed to be tilted with respect to a reference axis parallel to the optical axis of a light source unit, an optimal beam pattern can be formed even when the optical system is installed in a tilted manner according to the body line of the vehicle.

It should be noted that the effects of the present disclosure are not limited to those described above, and other effects of the present disclosure will be apparent from the following description.

### BRIEF DESCRIPTION OF THE DRAWINGS

FIGS. 1 and 2 are perspective views illustrating a lamp module according to an embodiment of the present disclosure.

FIG. 3 is a side view illustrating the lamp module according to an embodiment of the present disclosure.

FIG. 4 is a plan view illustrating the lamp module according to an embodiment of the present disclosure.

FIG. 5 is a schematic view illustrating a beam pattern formed by the lamp module according to an embodiment of the present disclosure.

FIG. 6 is a front view illustrating an optical unit according to an embodiment of the present disclosure.

FIG. 7 is a rear view illustrating the optical unit according to an embodiment of the present disclosure.

FIGS. 8 and 9 are exploded perspective views illustrating the optical unit according to an embodiment of the present disclosure.

FIG. 10 is a rear view illustrating a second light transmission part where a plurality of first shields are formed according to an embodiment of the present disclosure.

FIG. 11 is a schematic view illustrating beam patterns formed depending on the arrangement direction of first shields according to an embodiment of the present disclosure.

FIG. 12 is a schematic view illustrating a light source disposed below the center of a light path adjuster according to an embodiment of the present disclosure.

FIG. 13 is a schematic view illustrating paths of light incident from the light source disposed below the center of a light path adjuster according to an embodiment of the present disclosure.

FIG. 14 is a cross-sectional view illustrating first incident lenses and exit lenses corresponding thereto according to an embodiment of the present disclosure.

FIG. 15 is a schematic view illustrating light paths formed by the first incident lenses according to an embodiment of the present disclosure.

FIG. 16 is a schematic view illustrating light paths formed by a second incident lens according to an embodiment of the present disclosure.

FIG. 17 is a schematic view illustrating a reference axis parallel to the optical axis of a light source unit and the central axis of an exit lens according to an embodiment of the present disclosure.

FIG. 18 is a plan view illustrating a vehicle lamp according to another embodiment of the present disclosure.

FIGS. 19 and 20 are schematic views illustrating light sources and light path adjusters of lamp modules belonging to first and second groups, respectively, in FIG. 18.

### DETAILED DESCRIPTION

The advantages and features of the present disclosure, and methods for achieving them, will become apparent with reference to the embodiments to be described in detail below in conjunction with the accompanying drawings. However, the present disclosure is not limited to those embodiments, but may be implemented in various different forms. The embodiments are merely provided to fully disclose the scope of the present disclosure and to completely inform those skilled in the art of the scope of the disclosure, and the present disclosure is defined only by the scope of the claims. Throughout the specification, like reference numerals refer to like elements.

Accordingly, in some embodiments, well-known process steps, structures, and technologies are not described in detail in order to avoid ambiguous interpretation of the present disclosure.

The terminology used in this specification is intended to describe the embodiments and is not intended to limit the scope of the present disclosure. As used herein, the singular forms include plural forms as well unless explicitly stated otherwise. The terms “comprises” and/or “comprising,” as used herein, specify the presence of stated components, steps, operations, and/or elements but do not preclude the presence or addition of one or more other components, steps, operations, and/or elements. The term “and/or” includes each and all possible combinations of one or more of the associated listed items.

In addition, the embodiments disclosed in this specification will be described with reference to cross-sectional views and/or schematic views, which are ideal exemplary illustrations of the present disclosure. Therefore, modifications to the illustrated forms may occur due to manufacturing techniques and/or tolerances. Accordingly, the embodiments of the present disclosure are not limited to the specific forms depicted but include variations in shape resulting from the manufacturing processes. Also, in the drawings of the present disclosure, elements may be illustrated as being enlarged or reduced for convenience of description. Like reference numerals refer to like elements throughout the specification.

The present disclosure will hereinafter be described with reference to the accompanying drawings for explaining a lamp module and a vehicle lamp including the same according to embodiments of the present disclosure.

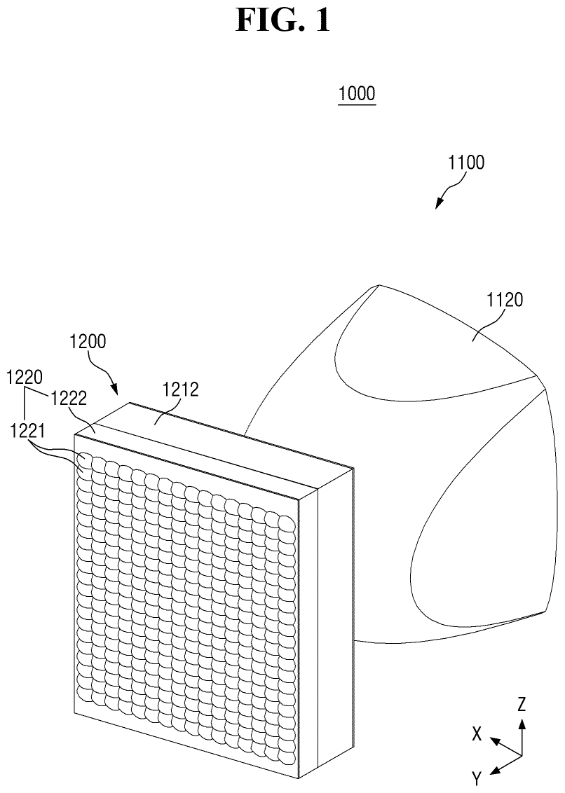

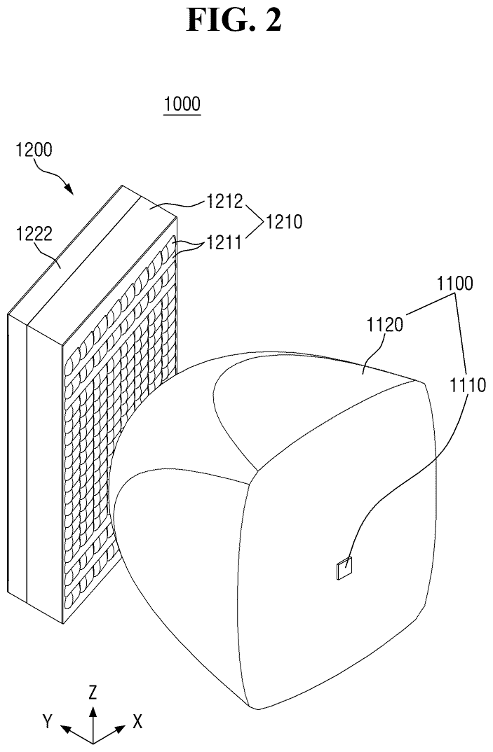

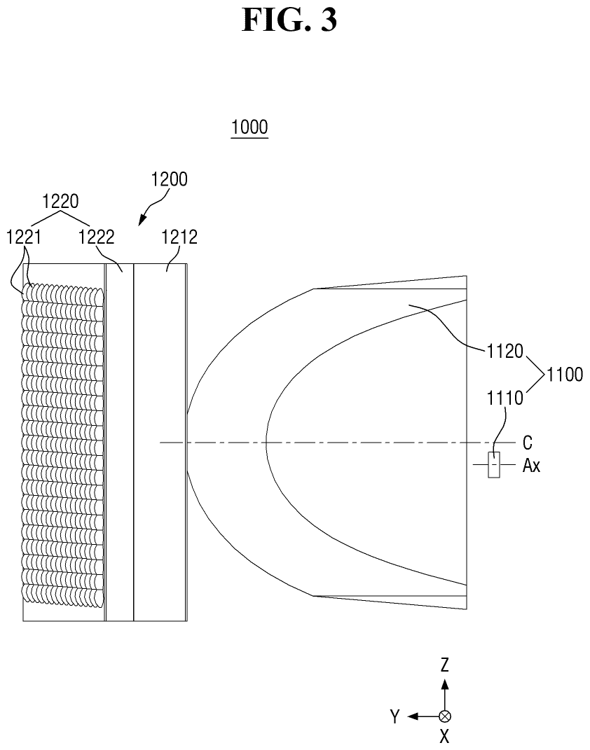

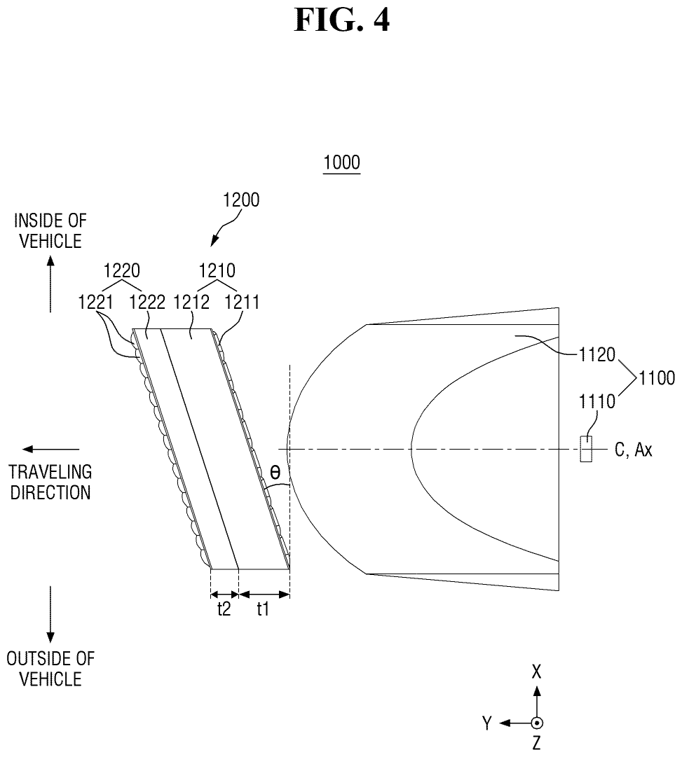

FIGS. 1 and 2 are perspective views illustrating a lamp module according to an embodiment of the present disclosure, FIG. 3 is a side view illustrating the lamp module according to an embodiment of the present disclosure, and FIG. 4 is a plan view illustrating the lamp module according to an embodiment of the present disclosure.

Referring to FIGS. 1 through 4, a lamp module 1000 according to an embodiment of the present disclosure may include a light source unit 1100 and an optical unit 1200.

In this embodiment, the lamp module 1000 is described by way of example as being used for a headlamp that irradiates light in the proceeding direction of a vehicle when the vehicle is being operated in low-light conditions (e.g., at night) so that the driver's forward field of vision is secured. However, the lamp module 1000 of the present disclosure is not limited to the use in a headlamp and may be used for various other types of vehicle lamps, such as a tail lamp, brake lamp, fog lamp, position lamp, turn signal lamp, daytime running lamp, and backup lamp.

When used as a headlamp, the lamp module 1000 of the present disclosure may form at least one of a low-beam pattern, which irradiates light below a predetermined cut-off line to avoid glare for drivers of preceding or oncoming vehicles and secure a wide field of view at close range, or a high-beam pattern, which irradiates light above the low-beam pattern to secure a longer viewing distance for the far front of the vehicle.

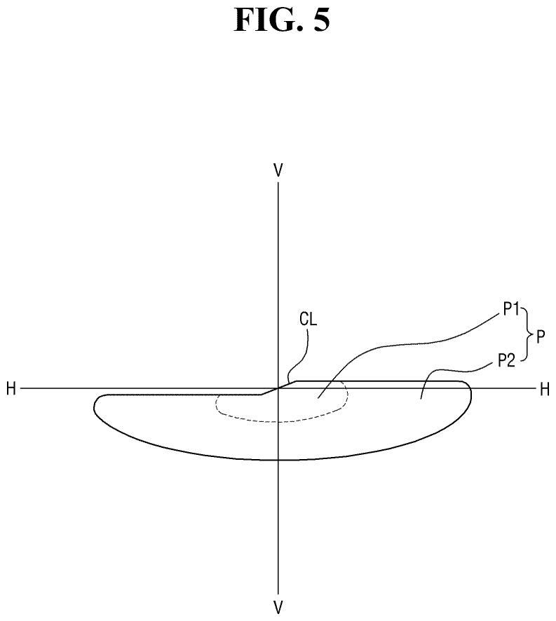

In this embodiment, a low-beam pattern P having a predetermined cut-off line CL is described by way of example as being formed by the lamp module 1000 of the present disclosure, as illustrated in FIG. 5. The low-beam pattern P may include a high-luminance region P1 having relatively greater brightness to improve the viewing distance in front of the vehicle and a spread region P2 formed to extend in at least one of an up-down direction or a left-right direction from the high-luminance region P1 while having relatively less brightness than the high-luminance region P1 in order to secure a wider field of view in front of the vehicle.

The light source unit 1100 may include a light source 1110 and a light path adjuster 1120.

The light source 1110 may emit light having an amount and color suitable for the intended use of the lamp module 1000 of the present disclosure. In this embodiment, the light source 1110 is described by way of example as being a semiconductor light-emitting element such as a light-emitting diode (LED). However, the light source 1110 is not limited thereto and may be implemented using various other types of light sources such as a laser diode (LD) or bulb. Depending on the type of light source used, optical elements such as reflectors, mirrors, or prisms may also be used.

The light path adjuster 1120 may function to convert the light emitted from the light source 1110 with a predetermined radiation angle range with respect to an optical axis Ax, which perpendicularly passes through the center of the light-emitting surface of the light source 1110, into collimated light approximately parallel to the optical axis Ax of the light source 1110. The light path adjuster 1120 may also serve to cause the light emitted from the light source 1110 to be more uniformly incident across the entire optical unit 1200.

Here, the light path adjuster 1120 may convert the light emitted from the light source 1110 into, for example, collimated light approximately parallel to the optical axis Ax of the light source 1110 when the optical axis Ax of the light source 1110 coincides with a center C of the light path adjuster 1120. In some embodiments, where the center C of the light path adjuster 1120 is spaced apart from the optical axis Ax of the light source 1110, the collimated light converted by the light path adjuster 1120 may not be parallel to the optical axis Ax of the light source 1110.

In this embodiment, an aspherical lens is described by way of example as being used as the light path adjuster 1120. However, this is merely exemplary to aid understanding of the present disclosure, and the light path adjuster 1120 may include not only an aspherical lens but also various other types of lenses, such as a Fresnel lens or a total internal reflection (TIR) lens, that are capable of converting the light emitted from the light source 1110 into collimated light.

The optical unit 1200 may serve to form a beam pattern suitable for the intended use of the lamp module 1000 of the present disclosure by allowing at least a portion of the light incident from the light source unit 1100 to be emitted.

In this embodiment, the optical unit 1200 may be tilted at a predetermined angle θ so that one side in the left-right direction is disposed more forward relative to the other side. This configuration is to allow the optical unit 1200 to be installed conforming to the body line or contour of the vehicle.

In other words, the lamp module 1000 of the present disclosure may be accommodated in an internal space defined by a lamp housing and a cover lens coupled to the lamp housing. The optical unit 1200 may be tilted and disposed so that at least a part of the optical system of the lamp module 1000 of the present disclosure conform with the outer surface shape of the cover lens that forms part of the vehicle's body line.

For example, when the outer surface of the cover lens is inclined or curved such that the cover lens is disposed further rearward going from the inner side to the outer side of the vehicle in the left-right direction, the optical unit 1200 may also be tilted, as illustrated in FIG. 4, so as to be disposed further rearward going from the inner side to the outer side of the vehicle.

In this embodiment, the optical unit 1200 is described by way of example as being disposed such that the outer side of the vehicle is further rearward than the inner side of the vehicle in the left-right direction (e.g., the lateral direction), but the opposite case is also possible.

The optical unit 1200 is installed in an inclined manner according to the body line of the vehicle body line because, where the cover lens is formed such that it is disposed more rearward going from the inner side to the outer side of the vehicle, if the light-emitting surface of the optical unit 1200 faces directly forward, one end of the optical unit 1200 may be obscured by the body of the vehicle near the cover lens, which may degrade the external appearance and result in partial blockage of the light emitted from the optical unit 1200, causing the beam pattern to be abnormally formed or light loss to occur.

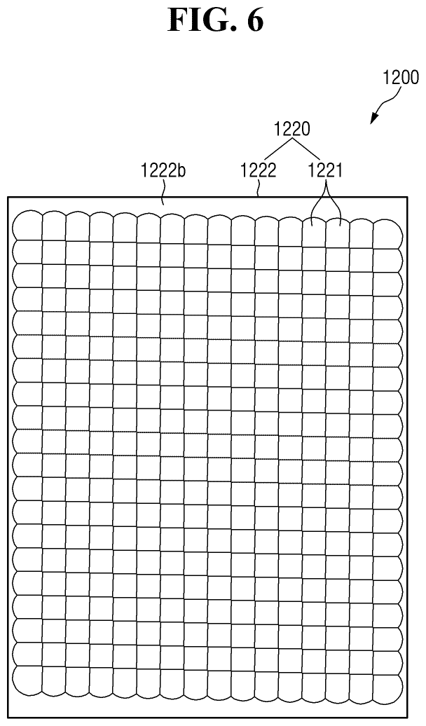

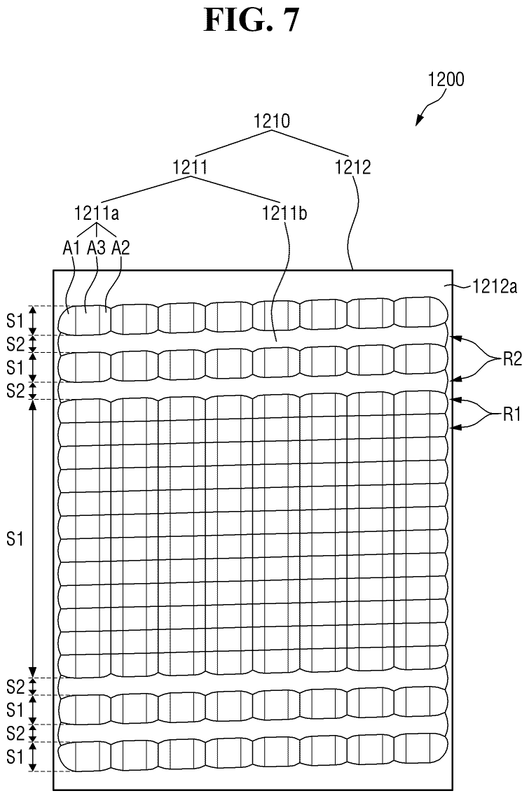

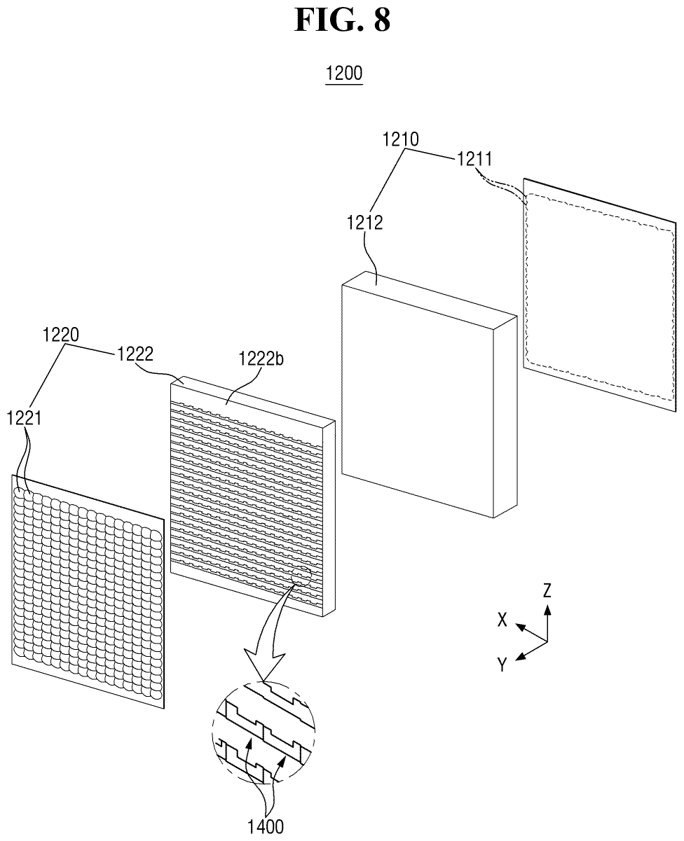

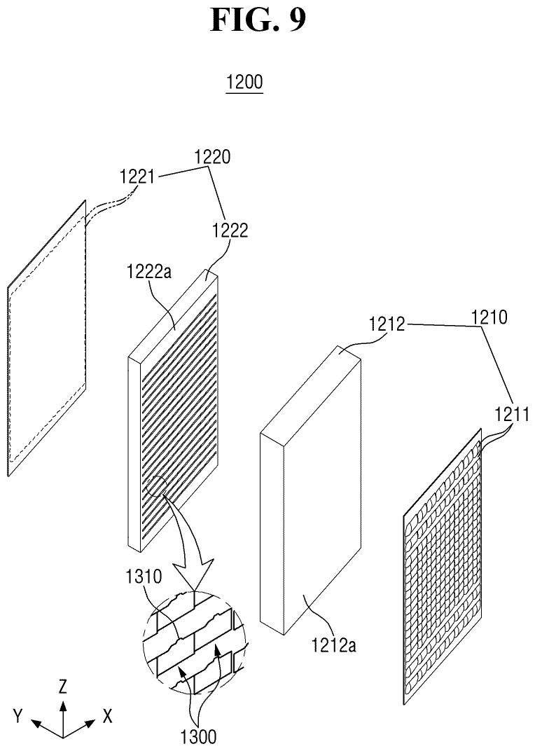

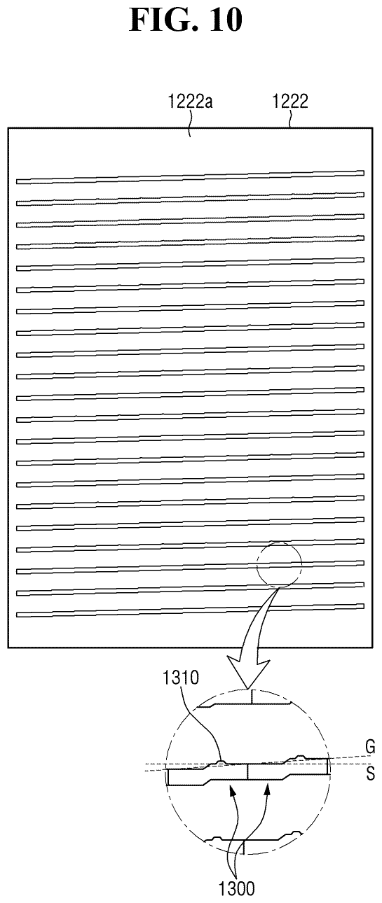

FIG. 6 is a front view illustrating an optical unit according to an embodiment of the present disclosure, FIG. 7 is a rear view illustrating the optical unit according to an embodiment of the present disclosure, FIGS. 8 and 9 are exploded perspective views illustrating the optical unit according to an embodiment of the present disclosure, and FIG. 10 is a rear view illustrating a second light transmission part where a plurality of first shields are formed according to an embodiment of the present disclosure.

Referring to FIGS. 6 through 10, an optical unit 1200 according to an embodiment of the present disclosure may include an incident lens unit 1210 and an exit lens unit 1220.

The incident lens unit 1210 may include a plurality of incident lenses 1211 and a first light transmission part 1212. The exit lens unit 1220 may include a plurality of exit lenses 1221 and a second light transmission part 1222. In this embodiment, the plurality of incident lenses 1211 and the plurality of exit lenses 1221 are described by way of example as being micro lenses having a relatively short focal length to miniaturize the lamp module 1000 of the present disclosure.

The plurality of incident lenses 1211 may be disposed on an incident surface 1212a of the first light transmission part 1212, and the plurality of exit lenses 1221 may be disposed on an emission surface 1222b of the second light transmission part 1222. In this case, an emission surface 1212b of the first light transmission part 1212 and an incident surface 1222a of the second light transmission part 1222 may be disposed to contact each other, so that light incident through the plurality of incident lenses 1211 is guided by the first and second light transmission parts 1212 and 1222 to the plurality of exit lenses 1221 for emission.

By way of example, a thickness t1 of the first light transmission part 1212 is described as being greater than a thickness t2 of the second light transmission part 1222. This configuration is to prevent the light incident through one of the plurality of incident lenses 1211 from proceeding not only to a corresponding exit lens but also to an adjacent exit lens, which may cause the light to be irradiated onto an unnecessary and/or unintended location.

In this case, a plurality of first shields 1300 may be formed on either the emission surface 1212b of the first light transmission part 1212 or the incident surface 1222a of the second light transmission part 1222 to obstruct part of the light proceeding toward the respective exit lenses 1221. By way of example, the plurality of first shields 1300 may be formed through deposition or coating. The plurality of first shields 1300 serve to form a low-beam pattern in which light is irradiated below a predetermined cut-off line CL by the lamp module 1000 of the present disclosure. The shape, size, and position of the plurality of first shields 1300 may vary or the plurality of first shields 1300 may be omitted depending on the beam pattern to be formed by the lamp module 1000 of the present disclosure.

The plurality of first shields 1300 may be formed on either the emission surface 1212b of the first light transmission part 1212 or the incident surface 1222a of the second light transmission part 1222 because the rear focal points of the respective exit lenses 1221 are disposed at or near the interface between the emission surface 1212b of the first light transmission part 1212 and the incident surface 1222a of the second light transmission part 1222.

The plurality of first shields 1300 may be arranged such that rows that extend in the left-right direction are arranged in the up-down direction. To prevent steps (e.g., height differences) from occurring between adjacent first shields 1300 in the left-right direction, the plurality of first shields 1300 may be inclined at a predetermined angle with respect to a horizontal line S. The inclination of the rows in which the plurality of first shields 1300 extend in the left-right direction means that a line G connecting the corresponding points of the shields 1300 arranged in the left-right direction is inclined at a predetermined angle with respect to the horizontal line S.

A protrusion 1310 may be formed at the top of at least one of the plurality of first shields 1300 to protrude upward. The protrusion 1310 may serve to reduce the brightness of light irradiated toward the position corresponding to a vehicle in front, thereby preventing glare for the driver of the vehicle in front.

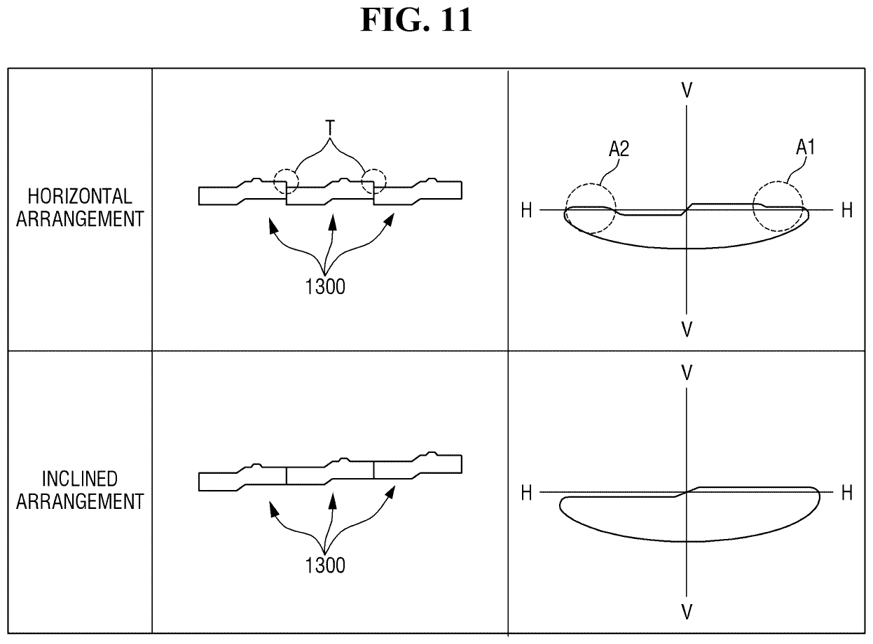

As described above, the rows of the plurality of first shields 1300 may be inclined at a predetermined angle because, as illustrated in FIG. 11, if a step difference T occurs between adjacent shields 1300 in the left-right direction, sections A1 and A2 of the cut-off line CL of the low-beam pattern P may deviate from their intended positions, which may degrade driver visibility or cause glare for the driver of the vehicle in front.

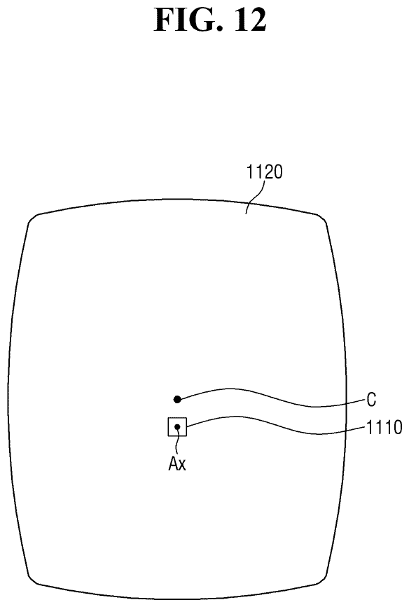

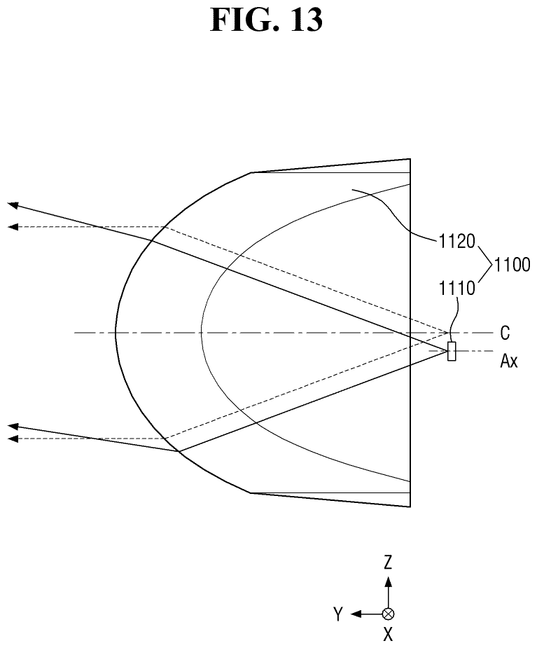

Meanwhile, when the collimated light converted by the light path adjuster 1120 is emitted coinciding with the optical axis Ax of the light source 1110, more light may be blocked by the plurality of first shields 1300, thereby reducing light efficiency. Therefore, in the embodiment of the present disclosure, as illustrated in FIG. 12, the light source 1110 may be disposed below the center C of the light path adjuster 1120. In this case, as illustrated in FIG. 13, the light emitted from the light path adjuster 1120 may proceed relatively upward with respect to the optical axis Ax of the light source 1110, thus reducing the light blocked by the plurality of first shields 1300 and improving light efficiency.

Positioning the light source 1110 below the center C of the light path adjuster 1120 encompasses not only a case where the entire light source 1110 is disposed below the center C of the light path adjuster 1120 but also a case where the optical axis Ax of the light source 1110 is disposed below the center C of the light path adjuster 1120.

In other words, the centers of the upper ends of the plurality of first shields 1300 may be disposed at or near the rear focal points of the respective exit lenses 1221, and the light incident through the plurality of incident lenses 1211 may be focused near the upper end centers of the plurality of first shields 1300. In the embodiment of the present disclosure, since the light emitted from the light path adjuster 1120 proceeds relatively upward, the focal point of the light incident through the plurality of incident lenses 1211 is raised. As a result, the amount of light blocked by the plurality of first shields 1300 may be relatively reduced, improving light efficiency.

In FIG. 13, the dotted lines indicate light paths when the optical axis Ax of the light source 1110 coincides with the center C of the light path adjuster 1120, and the solid lines indicate light paths when the optical axis Ax of the light source 1110 is disposed below the center C of the light path adjuster 1120.

Also, positioning the light source 1110 below the center C of the light path adjuster 1120 encompasses both a case where the entire light source 1110 is disposed below the center C of the light path adjuster 1120 and a case where the optical axis Ax of the light source 1110 is disposed below the center C of the light path adjuster 1120.

Meanwhile, on the emission surface 1222b of the second light transmission part 1222, a plurality of second shields 1400 may be formed to correspond to the respective first shields 1300.

The upper ends of the plurality of second shields 1400 may be disposed below the upper ends of the respective first shields 1300, thereby preventing glare from being generated in the beam pattern formed by the lamp module 1000 of the present disclosure.

In other words, since glare is mainly caused by light incident from the lower sides of the plurality of exit lenses 1221, the plurality of second shields 1400 may obstruct part of the light incident from the lower sides of the plurality of exit lenses 1221, thereby preventing the occurrence of glare.

Additionally, if the upper ends of the plurality of second shields 1400 are disposed above the upper ends of the respective first shields 1300, the cut-off line of the beam pattern by the lamp module 1000 of the present disclosure may not be properly formed. Therefore, the upper ends of the plurality of second shields 1400 may preferably be disposed below the upper ends of the respective first shields 1300.

The plurality of incident lenses 1211 may be divided into a plurality of sections S1 and S2 having different light distribution characteristics, and the plurality of sections S1 and S2 may be arranged in the up-down direction. The plurality of sections S1 and S2 having different light distribution characteristics may be understood as differing in at least one of the position, size, shape, or brightness of the region in which the light is irradiated.

The plurality of sections S1 and S2 may include first sections S1 and second sections S2. The first sections S1 may include one or more first lens rows R1, and the second sections S2 may include one or more second lens rows R2.

Here, each of the first lens rows R1 and second lens rows R2 may be inclined such that one side in the left-right direction is disposed above the other side. In other words, the rows in which the plurality of first shields 1300 extend in the left-right direction may be arranged at a predetermined angle with respect to the horizontal reference line.

In the optical unit 1200 described above, the first sections S1 and the second sections S2 may be alternately arranged in at least some regions, so that a more uniform image may be generally formed by the light emitted from the lamp module 1000 of the present disclosure.

For example, if only the first sections S1 are formed in the upper part, along the up-down direction, of the optical unit 1200 and only the second sections S2 are formed in the lower part, along the up-down direction, differences in light distribution characteristics between the one first lens rows R1 and the second lens rows R2 may lead to non-uniformity in an image, causing a sense of visual inconsistency and reduced visibility. Therefore, by alternately arranging the first sections S1 and the second sections S2, the sense of inconsistency may be reduced and the uniformity of an overall image may be improved.

In this embodiment, the first sections S1 and the second sections S2 are described by way of example as being alternately arranged in the upper and lower parts of the optical unit 1200, but this is merely exemplary to aid understanding of the present disclosure. The first sections S1 and the second sections S2 may also be alternately arranged in other regions of the optical unit 1200 as necessary to satisfy the light distribution characteristics of the beam pattern to be formed by the lamp module 1000 of the present disclosure.

Meanwhile, in the embodiment of the present disclosure, two or more first lens rows R1 may be formed continuously, and a single second lens row R2 may be formed. This configuration is to satisfy the light distribution characteristics required by the beam pattern to be formed by the lamp module 1000 of the present disclosure, and will be described later in further detail.

The plurality of incident lenses 1211 may include first incident lenses 1211a that form the first lens rows R1 and second incident lenses 1211b that form the second lens rows R2.

The first incident lenses 1211a may serve to enhance the high-luminance region P1 and the spread region P2 of the low-beam pattern P formed by the lamp module 1000 of the present disclosure. In this embodiment, each of the first lens rows R1 may be formed by two or more first incident lenses 1211a arranged in the left-right direction.

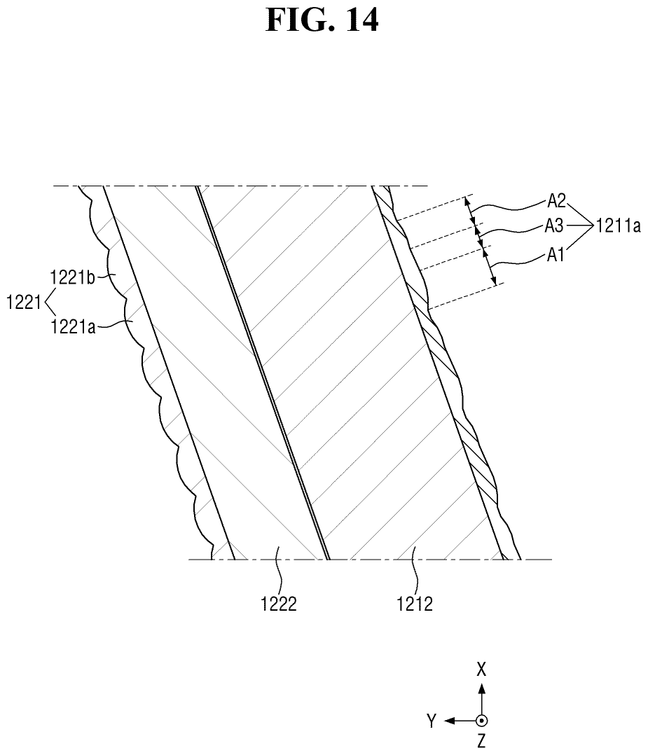

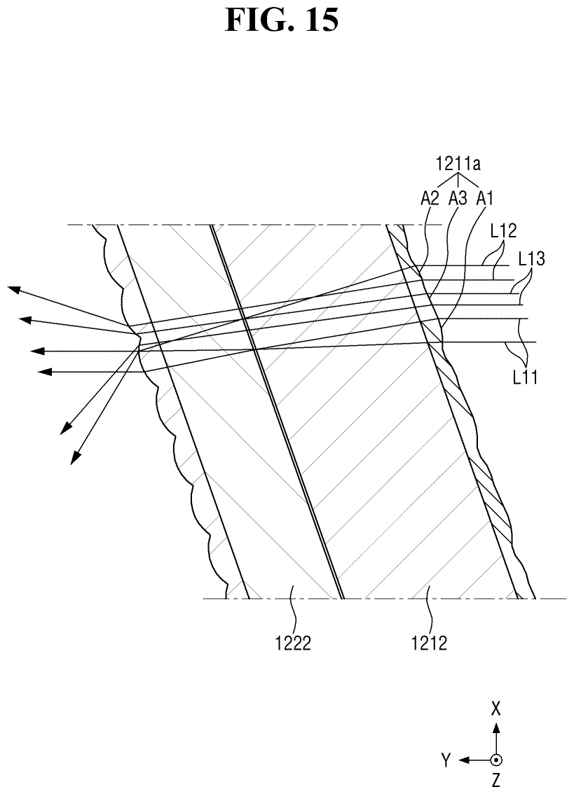

FIG. 14 is a cross-sectional view illustrating first incident lenses and exit lenses corresponding thereto according to an embodiment of the present disclosure, and FIG. 15 is a schematic diagram illustrating light paths formed by the first incident lenses according to an embodiment of the present disclosure.

Referring to FIGS. 14 and 15, first incident lenses 1211a according to an embodiment of the present disclosure may each be divided into a plurality of incident regions A1, A2, and A3 having different light-condensing performances (e.g., light-concentration powers). Light incident on each of the first incident lenses 1211a may be emitted through at least one of adjacent first or second exit lenses 1221a and 1221b, among a plurality of exit lenses 1221.

In this embodiment, two exit lenses 1221a and 1221b are described by way of example as corresponding to one first incident lens 1211a, but the present disclosure is not limited thereto. Alternatively, one first incident lens 1211a may correspond to at least one exit lens.

In addition, the plurality of incident regions A1, A2, and A3 having different light-condensing performances means that the focal points of beams of light incident on the plurality of incident regions A1, A2, and A3 differ in at least one direction, and may encompass not only a case where the light is focused on one point but also a case where the light proceeds as collimated light.

The plurality of incident regions A1, A2, and A3 may include a first incident region A1, a second incident region A2, and a third incident region A3.

Light L11 incident on the first incident region A1 may be focused on the rear focal point of either the corresponding first or second exit lens 1221a or 1221b to enhance the high-luminance region P1 of the low-beam pattern P.

In other words, when the optical unit 1200 is tilted such that one side in the left-right direction is disposed further rearward than the other side, the light incident on the optical unit 1200 may be refracted toward the other side, which is disposed relatively rearward among both sides of the optical unit 1200. In this case, the brightness of the high-luminance region P1 of the low-beam pattern P may be relatively reduced. To prevent this issue of reduced brightness in the high-luminance regions P1, the light L11 incident on the first incident region A1 may be configured to be emitted approximately in parallel with the optical axis Ax of the light source 1110 so that the high-luminance region P1 is enhanced with improved brightness.

Light L12 incident on the second incident region A2 may be emitted through at least one of the corresponding first or second exit lenses 1221a and 1221b to spread relatively more in the left-right direction, thereby reinforcing the spread region P2. To this end, light is focused to the point where the rear focal points of the first and second exit lenses are disposed, i.e., behind the interface where the emission surface 1212b of the first light transmission part 1212 and the incident surface 1222a of the second light transmission part 1222 contact each other. As a result, some of the light L12 incident on the second incident region A2 may be emitted in one direction, and the rest in the opposite direction, so that the spread region P2 may be extended on both sides.

Here, the first incident region A1 may be formed to have a greater width than the second incident region A2 to ensure sufficient brightness in the high-luminance region P1 formed by the lamp module 1000 of the present disclosure.

The third incident region A3 may be formed between the first and second incident regions A1 and A2, and light L13 incident on the third incident region A3 may proceed as collimated light to form the spread region P2 of the low-beam pattern P. However, the present disclosure is not limited thereto. If the spread region formed by the second section S2 to be described later sufficiently satisfies the light distribution characteristics, the third incident region A3 may be omitted, and the first and second incident regions A1 and A2 may be formed adjacent to each other without an intervening region.

Here, the third incident region A3 may have a cylindrical lens shape and may have curvature in the up-down direction to condense light incident from the light source unit 1100 in the up-down direction. Specifically, the third incident region A3 may have a semi-cylindrical shape that extends in the left-right direction.

The propagation directions of the beams of light incident on the first, second, and third incident regions A1, A2, and A3 may vary depending on the shape or curvature of the respective incident region.

Similarly to the aforementioned third incident region A3, a second incident lens 1211b may have a cylindrical lens shape that has curvature in the up-down direction to condense the light incident from the light source unit 1100 in the up-down direction, and may have a semi-cylindrical shape that extends in the left-right direction so that the light incident from the light source unit 1100 proceeds as collimated light in the left-right direction.

Here, each second lens row R2 may include a single second incident lens 1211b because, in the low-beam pattern P, the viewing distance that is secured by the high-luminance region P1 plays a relatively important role.

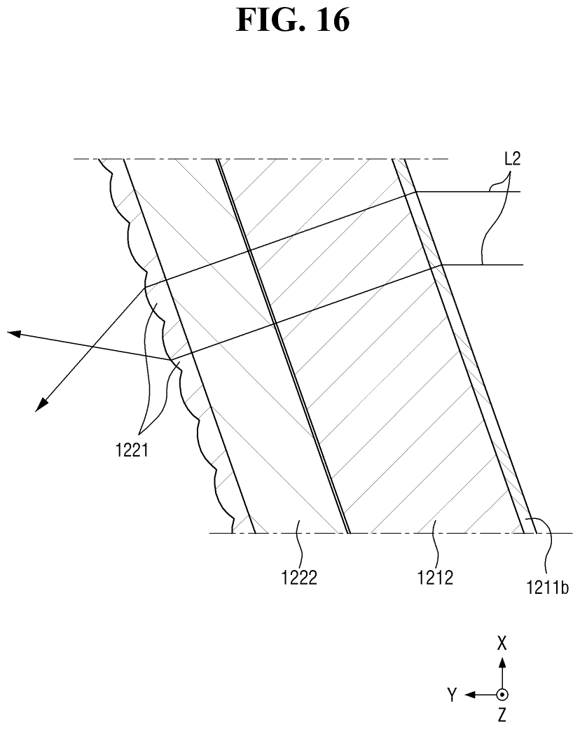

FIG. 16 is a schematic diagram illustrating light paths formed by a second incident lens according to an embodiment of the present disclosure.

Referring to FIG. 16, light L2 incident on a second incident lens 1211b according to an embodiment of the present disclosure may be incident on corresponding exit lenses 1221, and may spread in the left-right direction, thereby forming a spread region that satisfies the light distribution characteristics required by the lamp module 1000 of the present disclosure.

More specifically, the second incident lens 1211b may refract light in a direction toward the side of the optical unit 1200 that is disposed relatively rearward, depending on the tilt angle θ of the optical unit 1200, to proceed as collimated light. In addition, at least a portion of the light incident on the first incident lenses 1211a may be emitted through the respective exit lenses 1221 to spread in the left-right direction, thereby forming the spread region P2 of the low-beam pattern P by the lamp module 1000 of the present disclosure.

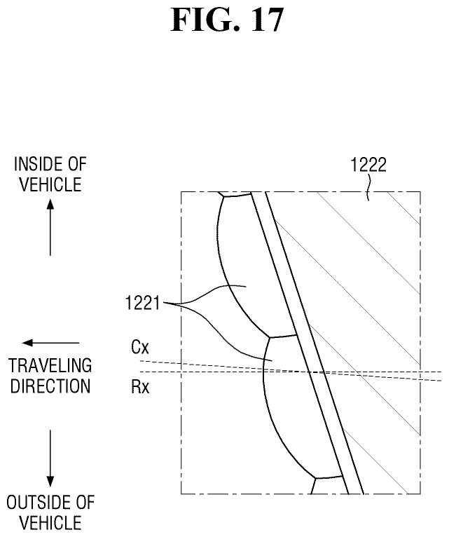

Meanwhile, as illustrated in FIG. 17, a central axis Cx of each of the plurality of exit lenses 1221 may be formed to be tilted at a predetermined angle in the left-right direction with respect to a reference axis Rx parallel to the optical axis Ax of the light source unit 1100, to allow the light to be emitted substantially forward even when the optical unit 1200 is tilted.

In other words, in the embodiment of the present disclosure, since the optical unit 1200 is tilted such that the outer side of the vehicle is disposed more rearward compared to the inner side of the vehicle in the left-right direction, the central axis Cx of each of the plurality of exit lenses 1221 may be tilted in a direction toward the inner side of the vehicle. In this case, each of the plurality of exit lenses 1221 may have a configuration in which the outer side with respect to the central axis Cx is formed larger than the inner side with respect to the central axis Cx.

Here, the central axis Cx of each of the plurality of exit lenses 1221 refers to an axis of axi-symmetry of each of the plurality of exit lenses 1221, and each of the plurality of exit lenses 1221 may have a shape that is axi-symmetric at least in part with respect to the central axis Cx.

In the above-described embodiment, a single lamp module 1000 is described by way of example, but the present disclosure is not limited thereto. Two or more lamp modules 1000 may be configured to be arranged in at least one direction depending on the required light distribution characteristics.

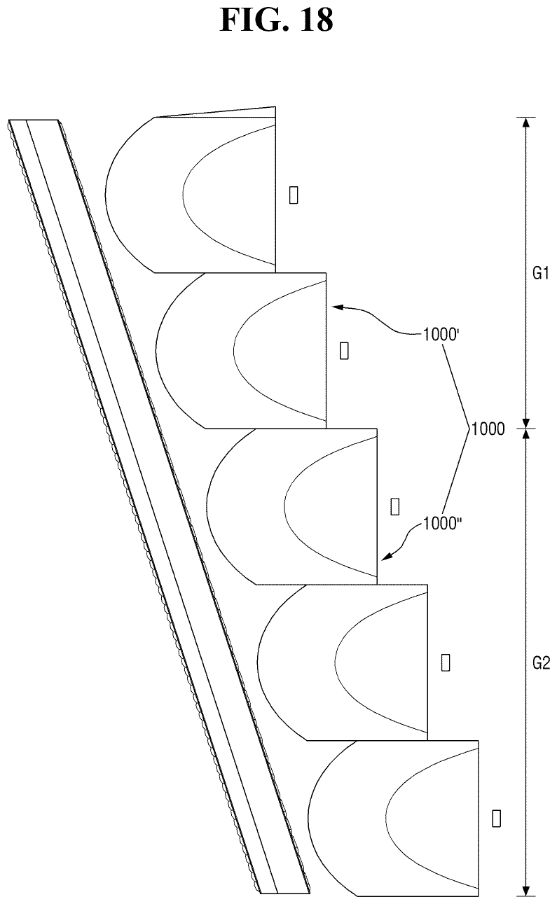

FIG. 18 is a plan view illustrating a vehicle lamp according to another embodiment of the present disclosure.

Referring to FIG. 18, a vehicle lamp 1 according to another embodiment of the present disclosure may include a plurality of lamp modules 1000 arranged in one direction. The plurality of lamp modules 1000 may serve similar functions as those of the lamp module 1000 of the previous embodiment, and thus, a detailed description of the plurality of lamp modules 1000 will be omitted.

In this embodiment, the plurality of lamp modules 1000 are described by way of example as being arranged in a left-right direction. Among the lamp modules 1000 arranged in the left-right direction, some lamp modules 1000′ disposed on the inner side (e.g., inboard) of the vehicle may be referred to as a first group G1, and other lamp modules 1000″ disposed on the outer side (e.g., outboard) of the vehicle relative to the first group G1 may be referred to as a second group G2.

In this case, optical units 1200 of the plurality of lamp modules 1000 may be integrally formed with one another, so that a uniform appearance may be implemented when viewed from the exterior.

Among the plurality of lamp modules 1000, the lamp modules 1000′ belonging to the first group G1 and the lamp modules 1000″ belonging to the second group G2 may have light sources 1110 disposed at different distances from centers C of respective light path adjusters 1120.

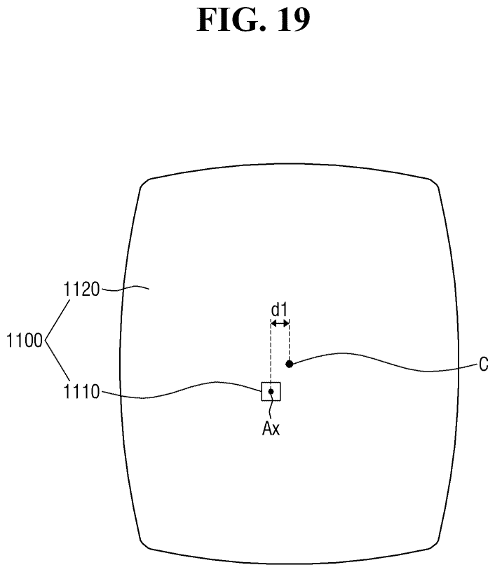

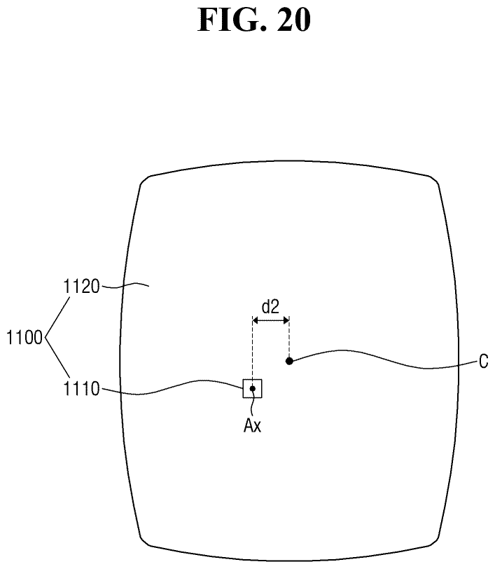

For example, as illustrated in FIGS. 19 and 20, in a case where a high-luminance region P1 of a low-beam pattern P is formed by the first group G1 and a spread region P2 of the low-beam pattern P is formed by the second group G2, the light source 1110 of a lamp module 1000′ belonging to the first group G1 may be disposed closer to a center C of a corresponding light path adjuster 1120 than the light source 1110 of a lamp module 1000″ belonging to the second group G2. This configuration may allow the light-condensing performance by the first group G1 to be improved.

Here, FIG. 19 is a diagram illustrating an example of a spacing distance d1 between the light source 1110 and the center C of the light path adjuster 1120 in each lamp module 1000′ belonging to the first group G1, and FIG. 20 is a diagram illustrating an example of a spacing distance d2 between the light source 1110 and the center C of the light path adjuster 1120 in each lamp module 1000″ belonging to the second group G2.

As described above, according to the embodiments of the present disclosure, by configuring at least some of the plurality of incident lenses 1211 to include a plurality of regions A1, A2, and A3 having different light-condensing performances, it is possible to enhance a high-luminance region P1 and a spread region P2 of a low-beam pattern P without separately adding an optical system. Thus, the configuration of a vehicle lamp may be simplified, while allowing an optimal beam pattern to be formed.

In addition, since the required light distribution characteristics of a beam pattern can be appropriately adjusted by adjusting the position of a light source 1110 with respect to the center C of a light path adjuster 1120, there is no need to separately provide an optical system according to the required light distribution characteristics. Thus, the configuration of a vehicle lamp may also be simplified, reducing cost.

Those skilled in the art will understand that the present disclosure may be implemented in other specific forms without changing the technical spirit or essential features. Therefore, the above-described embodiments should be understood as illustrative in all aspects and not as limiting. The scope of the present disclosure should be indicated by the claims, and all modifications or variations derived from the meaning and scope of the claims and their equivalents should be construed as being included in the scope of the present disclosure.

What is claimed is:

1. A lamp module comprising:
a light source unit that generates light; and
an optical unit that transmits at least a portion of the light incident from the light source unit to form a predetermined beam pattern,
wherein the optical unit is inclined such that a first lateral side thereof is disposed more forward than a second lateral side thereof in a left-right direction, and
wherein the optical unit includes:
an incident lens unit including a plurality of incident lenses; and
an exit lens unit including a plurality of exit lenses corresponding to the plurality of incident lenses.

2. The lamp module of claim 1, wherein the plurality of incident lenses are divided into a plurality of sections arranged in a vertical direction,
wherein the plurality of sections include:
a first section having a first light distribution characteristic; and
a second section having a second light distribution characteristic, and
wherein the optical unit is configured such that the first section and the second section are alternately arranged in at least some regions.

3. The lamp module of claim 2, wherein the first section and the second section are alternately arranged in at least one of an upper region or a lower region of the optical unit.

4. The lamp module of claim 2, wherein the first section includes at least one first lens row formed to extend in the left-right direction,
wherein the second section includes at least one second lens row formed to extend in the left-right direction, and
wherein the plurality of incident lenses include:
a first incident lens that forms the at least one first lens row and including a plurality of incident regions having different light-condensing performances; and
a second incident lens that forms the at least one second lens row.

5. The lamp module of claim 4, wherein the second incident lenses are implemented as cylindrical lenses.

6. The lamp module of claim 4, wherein the at least one first lens row includes a plurality of first lens rows arranged in a vertical direction, and
wherein the at least one second lens row includes a single second lens row.

7. The lamp module of claim 4, wherein a number of first lens rows is greater than a number of second lens rows.

8. The lamp module of claim 4, wherein light incident on the first incident lens is emitted through at least one of adjacent first or second exit lenses among the plurality of exit lenses, and
wherein the plurality of incident regions include a first incident region and a second incident region having different widths in the left-right direction.

9. The lamp module of claim 8, wherein the first incident region condenses light incident on the first incident lens at or near a rear focal point of a corresponding exit lens among the first and second exit lenses, thereby allowing a high-luminance region of the beam pattern to be enhanced.

10. The lamp module of claim 8, wherein the second incident region is configured such that light incident on the second incident lens is emitted through at least one of the first exit lens or the second exit lens, and is condensed at a position more rearward compared to the first incident region.

11. The lamp module of claim 8, wherein the plurality of incident regions further include a third incident region formed between the first incident region and the second incident region and configured to allow light incident on the first incident lens to proceed as substantially collimated light.

12. The lamp module of claim 1, wherein a central axis of each of the plurality of exit lenses is tilted in a direction toward the first lateral side of the optical unit with respect to a reference axis parallel to an optical axis of the light source unit, and
wherein each of the plurality of exit lenses is formed in a configuration in which a region disposed in the second lateral side of the optical unit with respect to the central axis is larger than a region disposed in the first lateral side of the optical unit with respect to the central axis.

13. The lamp module of claim 1, wherein the light source unit includes:
a light source that generates the light; and
a light path adjuster that adjusts a path of the light emitted from the light source, and
wherein the light source is disposed below a center of the light path adjuster.

14. A vehicle lamp that forms a beam pattern using a plurality of lamp modules arranged in one direction,
wherein each of the plurality of lamp modules includes:
a light source unit that generates light; and
an optical unit that transmits at least a portion of the light incident from the light source unit to form a predetermined beam pattern, and
wherein the optical unit is inclined to allow a first lateral side thereof to be disposed more forward than a second lateral side thereof in a left-right direction, and includes an incident lens unit including a plurality of incident lenses; and an exit lens unit including a plurality of exit lenses corresponding to the plurality of incident lenses.

15. The vehicle lamp of claim 14, wherein the light source unit includes:
a light source that generates the light; and
a light path adjuster that adjusts a path of the light emitted from the light source, and
wherein the light source is disposed below a center of the light path adjuster.

16. The vehicle lamp of claim 15, wherein in at least one of the plurality of lamp modules, the light source is disposed closer than at least another of the plurality of lamp modules to a center of the light path adjuster in the left-right direction.
